(19) United States
(12) Patent Application Publication
(10) Pub. No.: US 2006/0129753 A1
(43) Pub. Date: Jun. 15, 2006

(54) Dynamic packing of volatile memory

(75) Inventor: Robert Hasbun, Placerville, CA (US)

Correspondence Address: INTEL CORPORATION, P.O. BOX 5326, SANTA CLARA, CA, 95056-5326, US

(73) Assignee: INTEL CORPORATION

(21) Appl. No.: 11/013,219

(22) Filed: Dec. 14, 2004

(51) Int. Cl. G06F 12/00

(52) U.S. Cl. 711/104; 711/203

(57) ABSTRACT

A system and method for managing volatile memory which, may not simply look for a good fit in memory or store content according to rigid memory area classifications, but allocates memory to minimize the memory area requiring refresh and/or free memory areas so they may be powered down. A number of metrics such as age, nature of application, user of content and the like may be used to optimize packing of a volatile memory. Various specific embodiments are also disclosed.

### BACKGROUND

Volatile memories, such as dynamic random access memories (DRAMs) or static random access memories (SRAMs), are commonly used in electronic devices. Unlike non-volatile memories, volatile memories need continuous refreshing, and thus require power, for maintaining data in the memory. However, in portable devices, such as cell phones, laptops and other portable computing devices, it is desirable to reduce power consumption as much as possible to maximize the available “on time.”

Many volatile memories are designed to allow only portions of the memory with data refreshed; this is commonly referred to as a partial array refresh. Conventionally, the focus on RAM systems has been on minimizing the latency of initial access and/or maximizing available RAM. These solutions may be adequate for desktop (or wired) solutions; however, for mobile solutions, reducing power consumption as much as possible is a primary goal.

Accordingly, it would be desirable to further reduce power consumption in managing volatile memory for portable electronic devices where possible.

### BRIEF DESCRIPTION OF THE DRAWING

Aspects, features and advantages of the embodiments of the present invention will become apparent from the following description of the invention in reference to the appended drawing in which like numerals denote like elements and in which:

FIG. 1 is a block diagram of a memory compaction technique according to various example embodiments of the present invention;

FIG. 2 is a functional block diagram showing an example process for memory mapping and dynamic packing of content according to one or more embodiments of the present invention; and

FIG. 3 is a functional block diagram of an example embodiment for a wireless device adapted to perform one or more of the methods of the present invention.

### DETAILED DESCRIPTION

As volatile memory such as DRAM density increases in today's electronic devices it is more likely to have multiple DRAM chips in a single product. Accordingly, for power-sensitive applications, it would be desirable for a memory management system to be able to optimize the footprint of used memory such that as much of the DRAM as possible could be left without needing to be refreshed so unused memory chips may be powered down entirely when possible.

Various embodiments of the present invention may facilitate one or more of these aspects through a memory management system which, may not simply look for a good fit in memory or store content according to rigid memory area classifications, but allocates memory to minimize the memory area requiring refresh. Additionally, embodiments of the present invention, when freeing memory, may utilize a number of metrics to optimize dynamic packing of the memory.

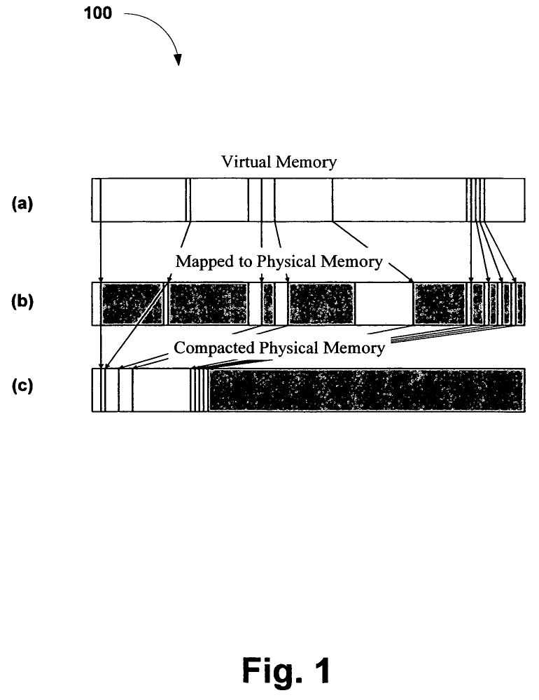

Turning to FIG. 1, an illustrative diagram 100 for managing volatile memory according to certain embodiments of the invention may use relocatable code, a full featured operating system including virtual memory and a memory management unit, although the inventive embodiments are not limited in these respects. In one embodiment, conventional virtual memory mapping may be preserved in that virtual addresses may be translated by a memory management unit (MMU) to correspond to physical memory addresses. However, instead of merely mapping the virtual memory addresses (FIG. 1, (a)) to physical memory addresses to increase memory speed and/or to find a good fit as conventionally done, embodiments of the present invention may map the virtual memory addresses (a) to physical memory addresses (c) in order to minimize the footprint of the physical memory.

Standard memory mapping may often result in heavily fragmented or non-contiguous storage of content in the physical memory (FIG. 1, (b)) thereby potentially requiring refresh in memory portions or arrays which are underutilized.

By way of contrast, with the example embodiments of the present invention, significant areas of the physical memory (FIG. 1, (c)) may not be utilized at all and thus these areas may not require a refresh or may be powered down entirely. As used herein, “content” means data, bits, information, program code and/or other representations capable of being stored in, or represented by characters stored in, a volatile memory. Preferably, although not required, content may be packed in the physical memory in a substantially hierarchical manner such that content likely to be retained in memory the longest is allocated an area of the memory adjacent content having a similar estimate for longevity. For example, content likely to be retained for the longest period (also referred to herein as “persistent” content) may be allocated in the physical memory in substantially contiguous blocks beginning at one end or side of the memory. Also, as content ages, it is aged in the manner of generational file systems such that the management of more temporary content minimizes the impact of maintaining the packed memory. The longer content remains in the system; it is treated as more and more persistent.

Likewise, initial, and more temporary content may be placed in areas of the physical memory, for example temporary buffer areas, apart from the longer term content. In this manner, the memory areas including more persistent content gravitate together, and may be continually refreshed, whereas buffer areas and other temporal memory areas such as the heap might not or be powered down entirely.

In certain embodiments, initial physical memory mapping could be performed in a conventional manner (as shown in example (b) of FIG. 1) and the physical memory could subsequently be compacted/packed to reduce the overall footprint of the memory. Such packing could be performed periodically or upon occurrence of an event such as initiation of a low power mode or completion of an application. However, in other embodiments, initial memory mapping may take into account an estimated longevity of the content to be stored in an effort to simplify subsequent compaction of the volatile memory.

Accordingly, as used herein the term “mapping” may refer to the initial allocation of memory, the rearrangement of content already present in memory or some combination of both. Further, the term “packing” is broadly used herein to mean that content may be initially placed or rearranged in the physical memory to minimize the footprint in the physical memory.

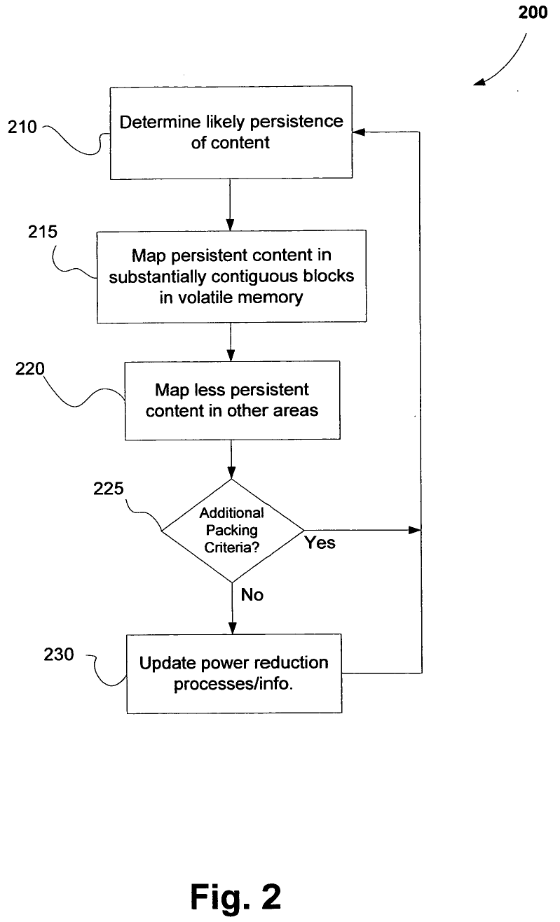

Turning to FIG. 2, a method 200 for storing content in volatile memory may generally include determining 210 the likely persistence for one or more parts of the content and arranging 215, 216 the one or more parts into a portion of the volatile memory to reduce power consumption of the volatile memory.

In one or more exemplary embodiments, the likely persistence may be determined 210 by evaluating, for example, age of the content, the owner of the content (e.g., system vs. user), the nature of an application associated with the content, the type of content to be stored (e.g., OS, system files, drivers, user data), and/or any relational attributes in applications/data. If packing is performed for content already stored in memory, the age of the existing content in allocated memory could be observed in determining likelihood of persistence. The skilled artisan would also recognize that various other metrics may be used to optimize the footprint of stored content in the volatile memory.

As previously mentioned the content likely to be most persistent may be mapped 215 and/or stored 220 in substantially contiguous physical blocks of the volatile memory preferably beginning at one side of the physical memory as shown in FIG. 1(c). Other, more potentially temporary content may be first allocated to buffer areas of the physical memory which may not be subject to long term refreshing or any refreshing at all.

Persistent content may alternatively, or in addition, be determined 210 based on one or more descriptors associated with the content. In one example embodiment, content may include one or more descriptors to assist in defining one or more attributes of the content. Such descriptors might be a value which allows the memory management system to know how to treat the content. Example descriptors could be used to quickly identify whether, to compact the content, not to compact the content and/or if it is uncertain how to treat the content. Optimizing the footprint of volatile memory according to the various inventive embodiments may be particularly valuable in multimedia applications having large data sets where, for example, during video encoding or while viewing a movie, a system might utilize large amounts of random access memory (RAM) but during standby, the amount of RAM allocated is significantly less.

Mapping 215 content may include characterizing the likely persistence of the content determined in step 210 and arranging the content in somewhat of a hierarchical order when possible although the inventive embodiments are not limited in this respect. Preferably, more persistent content is mapped 215 in substantially contiguous blocks of the physical memory and less persistent content is mapped 220 is other areas of the physical memory. Thus the fragmentation of physical memory may be reduced due to the deletion of the less persistent content. To this end, application stacks, which tend to be allocated and exist until an application is terminated, might be packed with its associated application as well.

If additional packing criteria, such as periodic timers, change of power saving mode, deletion of data, termination or opening of an application or other event which may affect memory are encountered 225, the packing process may be performed as desired. Additionally, when freeing memory, the memory manager may utilize a number of metrics which evokes optimization or packing. These factors might include for example, processor activity, percentage of memory fragmentation, amount of memory used and the like.

Lastly, depending on the configuration used for partial array refresh or memory power down, power reduction processes or corresponding data for these types of processes may be updated 230 as suitably desired to reflect the used, unused, packed, and unpacked portions of the physical memory resulting from optimization.

Under certain circumstances, packing memory may be very processing intensive and thus it may be desirable to evaluate whether packing could actually consume more power than refreshing underutilized volatile memory areas. Accordingly, one or more power saving thresholds, which might depend on the type and/or size of the volatile memory used, the amount of work vs packing achieved, the amount of time the system is in standby/sleep vs active could be used to determine whether the volatile memory should be packed at all or to what degree the memory should be packed.

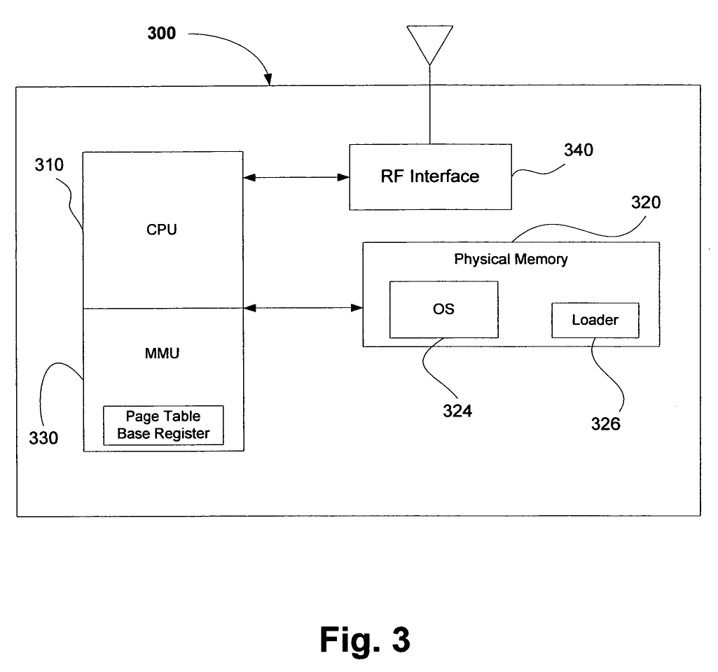

Turning to FIG. 3, a system 300 for dynamic packing of volatile memory may include at least one central processing unit (CPU) 310, a memory management unit 330, a physical memory 320 and executable code and/or data to perform the processes described herein. CPU 310, MMU 330 and memory 320 may be adapted to communicate and interact with one another to perform one or more of the memory packing methods described herein.

Memory 320 may be any volatile memory device or plurality of devices for storing content. For example, memory 320 may comprise one or more DRAMs or SRAMs capable of storing at least a portion of an operating system (OS) 324 and/or other applications and/or data for use by CPU 310. OS 324 preferably includes code for virtual memory mapping and maintains a page table for the processes used by CPU 310 to translate virtual memory addresses into physical memory addresses. Memory 320 may also include a loader 326 or dispatcher code for reading or attaching descriptors from/to the content to assist in identifying a packing attribute as previously described.

MMU 330 may be any hardware, software or combination of hardware and software configured to manage the resources of physical memory 320 and perform packing of content as described herein. In certain embodiments, MMU 330 may utilize code from OS 324 and include a page table register to aid hardware to quickly walk page tables in memory and locate pages of running processes. Accordingly, existing operating systems for mobile devices could be modified to implement the dynamic packing described herein without hardware redesign.

System 300 may optionally further include a radio frequency (RF) interface 340 to facilitate wireless communications. RF interface 340 may be configured for cellular telephone, wireless local area network (WLAN) or wireless broadband communications as suitably desired. RF interface 340 may be any component or combination of components adapted to send and receive signals. Preferably, RF interface 340 is adapted to send and receive spread spectrum or OFDM modulated signals, although the embodiments are not limited to any particular modulation scheme or air interface. Various RF interface designs and their operation are known in the art and the description thereof is therefore omitted.

System 300 may be any portable computing or information device, preferably although not necessarily having wireless communication capabilities, such as a cell phone, personal digital assistant, portable computer, personal entertainment device, portable navigation device or other devices where advantages of the inventive embodiments could be suitably applied. Accordingly, the functions and/or specific configurations of system 300 could be modified as desired.

The components and features of system 300 may be implemented using any combination of discrete circuitry, application specific integrated circuits (ASICs), logic gates and/or single chip architectures. Further, the features of system 300 may be implemented using microcontrollers, programmable logic arrays and/or microprocessors or any combination of the foregoing where suitably appropriate.

It should be appreciated that system 300 shown in the block diagram of FIG. 3 is only one functionally descriptive example of many potential implementations. Accordingly, division, omission or inclusion of block functions depicted in the accompanying figures does not infer that the hardware components, circuits, software and/or elements for implementing these functions would necessarily be combined, divided, omitted, or included in embodiments of the present invention.

Unless contrary to physical possibility, the inventors envision the methods described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

The invention claimed is:

1. A method of storing content in a volatile memory, the method comprising:
relocating content in volatile memory to reduce fragmentation of stored content.

2. The method of claim 1 wherein a virtual address is remapped to a new physical address and the virtual memory remains unchanged.

3. The method of claim 2 wherein relocating is performed utilizing a memory management unit and at least one page table.

4. The method of claim 1 wherein the volatile memory comprises one of a dynamic random access memory (DRAM) or a static random access memory (SRAM).

5. The method of claim 1 wherein mapping the content comprises determining a likelihood persistence of one or more parts of the content, and packing the one or more parts which may be relatively persistent into a portion of the volatile memory to reduce power consumption of the volatile memory.

6. The method of claim 5 wherein reducing power consumption of the volatile memory comprises at least one of performing a partial array refresh only on the portion having packed content or turning off one or more portions of the volatile memory other than the portion having packed content.

7. The method of claim 5 wherein determining a likelihood of persistence comprises identifying one or more characteristics of one or more parts, the characteristics selected from the group consisting of a type association of the one or more parts or an age of the one or more parts.

8. The method of claim 5 wherein the determined likelihood of persistence is used to minimize remapping when memory containing the content is subsequently freed.

9. The method of claim 7 wherein the one or more characteristics of the one or more parts is identified, at least in part, by a descriptor associated with the one or more parts.

10. A method of storing content in a volatile memory, the method comprising:
packing at least a portion of the content in the volatile memory to reduce power consumption of the volatile memory.

11. The method of claim 10 wherein the volatile memory comprises one of a dynamic random access memory (DRAM) or a static random access memory (SRAM).

12. The method of claim 10 wherein packing at least a portion of the content in the volatile memory comprises observing one or more attributes of the content to be stored and mapping content having certain attributes in substantially contiguous blocks of the volatile memory.

13. The method of claim 12 further comprising refreshing only the portions of the volatile memory containing content having the certain attributes.

14. The method of claim 12 wherein the one or more attributes observed include at least one of an age of the content, an associated type of content, or an owner of the content.

15. The method of claim 12 wherein attributes of the content are observed based one or more descriptors associated with the content to be stored.

16. The method of claim 15 wherein the one or more descriptors comprises one of a first descriptor indicating content to be packed, a second descriptor indicating content not to be packed or a third descriptor indicating unknown treatment.

17. A method of storing content comprising:
refreshing only portions of a volatile memory having packed content.

18. The method of claim 17 wherein the volatile memory comprises a dynamic random access memory (DRAM).

19. The method of claim 17 further comprising turning off one or more chips of the volatile memory not having packed content.

20. A storage medium storing machine readable instructions for:
packing content in a volatile memory to reduce fragmentation of stored content.

21. The storage medium of claim 20 further including machine readable instructions for refreshing only portions of the volatile memory storing packed content.

22. The storage medium of claim 20 wherein the volatile memory comprises one of a dynamic random access memory (DRAM) or a static random access memory (SRAM).

23. The storage medium of claim 20 further including machine readable instructions for turning off one or more portions of the volatile memory not including packed content.

24. The storage medium of claim 20 wherein packing content in the volatile memory to reduce fragmentation includes arranging content in substantially contiguous blocks of the volatile memory.

25. The storage medium of claim 24 wherein the content is arranged substantially based on its likely persistence.

26. A wireless device comprising:
a memory management unit;
a volatile memory in communication with the memory management unit; and
an radio-frequency (RF) interface communicatively coupled to the volatile memory; wherein the memory management unit is adapted to pack content in the volatile memory to reduce power consumption of the volatile memory.

27. The device of claim 26 wherein the volatile memory comprises a dynamic random access memory (DRAM).

28. The device of claim 26 wherein the memory management unit packs the content in the volatile memory in substantially contiguous blocks to reduce fragmentation of the content.

29. The device of claim 28 wherein the memory management unit packs the content based on a likely persistence of the content.

30. The device of claim 29 wherein the likely persistence of the content is determined in accordance with at least one of, a user of the content, a nature of an application associated with the content, or an age of the content.
